(19) United States
(12) Patent Application Publication
(10) Pub. No.: US 2002/0030080 A1
(43) Pub. Date: Mar. 14, 2002

(54) Tool for improving decorative upholstery tacking process

(76) Inventor: Steven Douglas Lord, Reading, PA (US)

Correspondence Address: Steven Douglas Lord, 624 Mercer St., Reading, PA, 19601, US

(21) Appl. No.: 09/925,875

(22) Filed: Aug. 7, 2001

Related U.S. Application Data
(60) Provisional application No. 60/224,018, filed on Aug. 10, 2000.

(51) Int. Cl. B25C 7/00

(52) U.S. Cl. 227/147

(57) ABSTRACT

A tool to drive in decorative upholstery tack and add stability while keeping fingers safe comprising a concave area to recieve the tack and a shaft with concave area for fingers to hold.

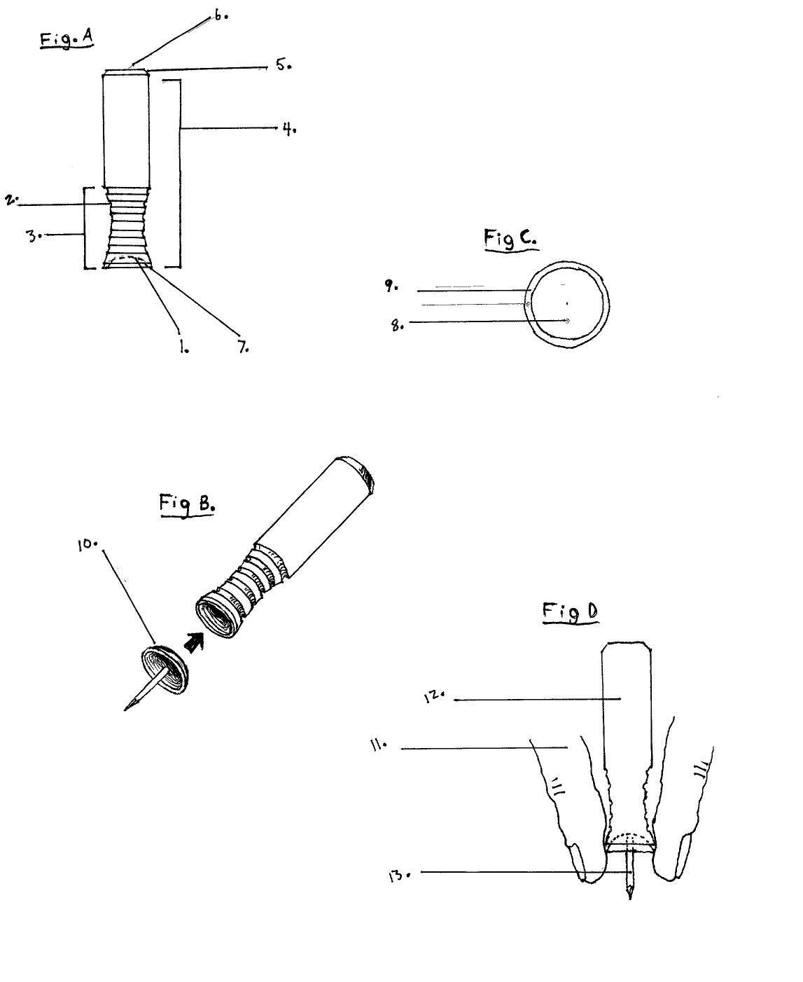

### BACKGROUND

This invention relates to a tool for improving the decorative upholstery tacking process. Historically decorative upholstery tacks were driven in to desired surface by holding tack with your fingers and hammering with a tack hammer. When I was doing my tacking I kept hitting my fingers with the hammer. I looked around for a tool to solve the problem to no avail. I propose a tool that solves this problem while also creating more control and stability at the same time. I did a patent search to see if there was any tool already in existence that did what I ask of mine, I found none. Some of the tools I found have certain elements that mine will possess, such as a shaft, concave area to receive tack. Most of them rely on magnets and intricate slits to fit tacks or nails. My tool relies only on the fingers and outside shape of tool to hold tack in place.

### PERTINENT PRIOR ART

U.S. Pat. No. 608,555 (Nazel) . . . U.S. Pat. No. 2,049,459 (Lipson) . . . U.S. Pat. No. 2,666,201 (Van Orden) . . . U.S. Pat. No. 2,780,811 (Rodin) . . . U.S. Pat. No. 3,218,030 (Baro) . . . U.S. Pat. No. 3,549,075 (Tsunami) . . . U.S. Pat. No. 3,716,088 (Grey) . . . U.S. Pat. No. 3,764,054 (Monacelli) . . . U.S. Pat. No. 4,029,135 (Searfoss, jr.) . . . U.S. Pat. No. 4,061,225 (Pettitt) . . . U.S. Pat. No. (4,676,4249 Meadow, et al.) U.S. Pat. No. (4,709,765 (Campanell).

### BRIEF DESCRIPTION OF DRAWINGS

Fig. A

1. concave area to receive tack

2. groves

3. concave area

4. shaft

5. bevelled edge

6. surface to be met by driving force

7. lip for fingers

Fig. B

10. tack

Fig. C

8. concave to receive tack

9. lip for fingers

Fig. D

11. fingers

12. tool

13. tack

### DETAILED DESCRIPTION OF INVENTION

The tool I am proposing is comprised of a heat tempered steel shaft (fig. A, no. 4) that can be easily turned on a lathe. The top of the shaft (fig. A, no. 6) is flat with a beveled edge (fig. A, no. 5) further down the shaft is a concave area (fig. A, no. 3) that has grooves (fig. A, no. 2) to aid gripping tool. It then flares back out to form a small lip (fig. A, no. 7), fig. B.), (fig. D.) this is the main difference from the prior art. This simple concave area and lip when holding the tack in place with fingers is unique. This simple design does more than keep fingers away from hammering (fig. D.) it also keeps tack more in place when driving it into surface which helps in added control and speed.

### SUMMARY

In summary my invention will improve the decorative upholstery tacking process by keeping the fingers away from the driving force by the way the tool is held. The invention is held by holding the tool and the tack at the same time. The unique design of the tool allows this to happen very efficiently thus enhancing safety, control, stability, and faster tacking time.

1. What I claim as my invention is how the tool is held, it is held with the fingers holding both the tool and the decorative upholstery tack at the same time, this adds in improved safety, control and speed of use.

2. What I claim as my invention is a tool designed exclusively for the decorative upholstery tacking process.
